(19) United States
(12) Patent Application Publication
(10) Pub. No.: US 2012/0076132 A1
(43) Pub. Date: Mar. 29, 2012

(54) SWITCH AND TELEPHONE SEARCHING METHOD

(75) Inventors: CHIH-FENG LAI, Tu-Cheng (TW); HUAI-CHIH FAN, Tu-Cheng (TW)

(73) Assignee: HON HAI PRECISION INDUSTRY CO., LTD., Tu-Cheng (TW)

(21) Appl. No.: 12/979,349

(22) Filed: Dec. 28, 2010

(30) Foreign Application Priority Data
Sep. 29, 2010 (CN) 201010296519.0

(51) Int. Cl. H04L 12/66

(52) U.S. Cl. 370/352

(57) ABSTRACT

A switch includes a call record table recording at least one outgoing call. When the switch receives an incoming call, the switch searches the call record table to find a mapping outgoing call with a destination telephone number the same as a source destination telephone number of the incoming call. Then the switch obtains a communication line number of the mapping outgoing call in the call record table, and sends a ringing signal to a local telephone corresponding to the obtained communication line number.

### BACKGROUND

1. Technical Field

The present disclosure relates to network communications, and more particularly to a switch and a telephone searching method of the switch.

2. Description of Related Art

With the development of voice over Internet protocol (VoIP) technologies, private branch exchanges (IP-PBXs) are now in widespread use. IP-PBXs enable enterprises and families to enjoy voice communications.

However, when one IP-PBX corresponds to more than one telephone, it is different to find one telephone mapping with an incoming call because each telephone only has an extension number and does not has a unique public telephone number.

### BRIEF DESCRIPTION OF THE DRAWINGS

The details of the disclosure, both as to its structure and operation, can best be understood by referring to the accompanying drawing, in which like reference numbers and designations refer to like elements.

FIG. 1 is a schematic diagram of an application environment of one embodiment of a switch in accordance with the present disclosure;

FIG. 2 is a schematic diagram of functional modules of one embodiment of the switch in accordance with the present disclosure;

FIG. 3 is a flowchart of one embodiment of a telephone searching method in accordance with the present disclosure;

FIG. 4 is a transport diagram showing the switch of FIG. 2 processing an outgoing call in accordance with the present disclosure; and

FIG. 5 is a transport diagram showing the switch of FIG. 2 processing an incoming call in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

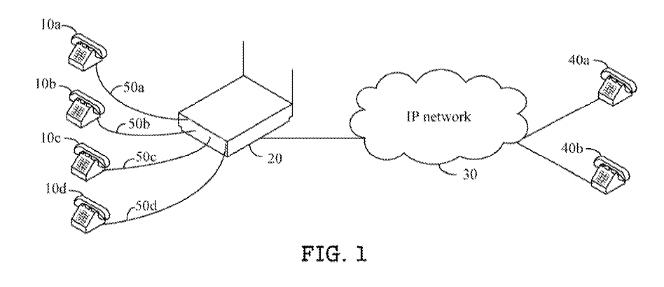

FIG. 1 is a schematic diagram of an application environment of one embodiment of a switch 20 in accordance with the present disclosure. In one embodiment, the switch 20 may be an Internet protocol (IP) private branch exchange (IP-PBX). The switch 20 is connected to a plurality of local telephones 10a-10d (only 4 shown) via a plurality of communication lines 50a-50d (only 4 shown). Each of the communication lines 50a-50d corresponds to one of the local telephones 10a-10d, and is assigned a communication line number. Each of the local telephones 10a-10d has a private telephone number, namely an extension number. The switch 20 has a local public telephone number. For example, the communication line numbers of the communication lines 50a-50d may respectively be 1, 2, 3, and 4. The private telephone numbers of the local telephones 10a-10d may respectively 6211, 6212, 6213, and 6214. The local public telephone number of the switch 20 may be 5432022824.

The switch 20 communicates with a plurality of remote telephones 40a-40b (only two shown) over an IP network 30. Each of the remote telephones 40a-40b has a remote public telephone number. For example, the remote public telephone number of the remote telephone 40a is 9561033713, and the remote public telephone number of the remote telephone 40b is 9561033715.

In one embodiment, if the local telephone 10b dials the remote public telephone number of the remote telephone 40b, then the switch 20 receives an outgoing call from the local telephone 10b via the communication line 50b. Accordingly, the switch 20 records the outgoing call in a call record table, and then transmits the outgoing call to the remote telephone 40b over the IP network 30. In detail, the switch 20 records the communication line number of the communication line 50b, the private telephone number of the local telephone 10b, and the remote telephone number of the remote telephone number 40b in the call record table.

Afterwards, when the switch 20 receives an incoming call from the remote telephone 40b over the IP network 30, the switch 20 searches the call record table to find the outgoing call mapping with the incoming call, namely the outgoing call from the local telephone 10b. Then, the switch 20 obtains the communication line number of the communication line 50b in the call record table, and sends a ringing signal to the local telephone 10b corresponding to the obtained communication line number of the communication line 50b.

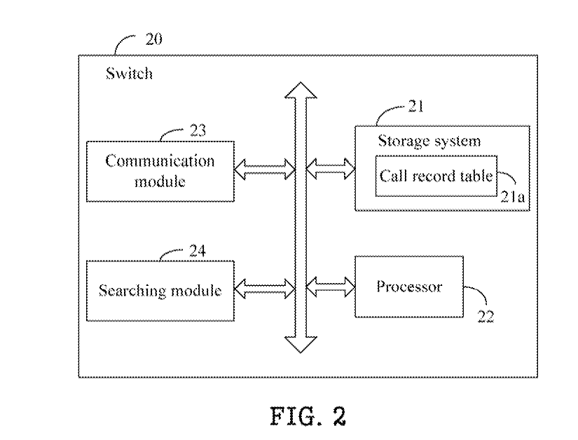

FIG. 2 is a schematic diagram of functional modules of one embodiment of the switch 20 in accordance with the present disclosure. In one embodiment, the switch 20 includes a storage system 21, at least one processor 22, a communication module 23, and a searching module 24. The modules 23-24 may comprise computerized code in the form of one or more programs that are stored in the storage system 21. The computerized code includes instructions that are executed by the at least one processor 22 to provide functions for the modules 23-24.

In one embodiment, the storage system 21 is operable to store a call record table 21a. The call record table 21a records at least one outgoing call from the at least one local telephone 10a-10d to at least one remote telephone 40a-40b. The at least one outgoing call includes the at least one communication line number corresponding to the at least one local telephone 10a-10d, at least one destination telephone number, and at least one private telephone number of the at least one local telephone 10a-10d. The at least one destination telephone number of the at least one outgoing call is at least one remote public telephone number of the at least one remote telephone 40a-40b. For example, if one outgoing call is from the local telephone 10b to the remote telephone 40b, the call record table 21a records the communication line number 2 of the communication line 50b, the private telephone number 6212 of the local telephone 10b, and the remote public telephone number 9561033715 of the remote telephone 40b.

When the remote telephone 40a or 40b dials the local public telephone number of the switch 20, the communication module 23 receives an incoming call from the remote telephone 40a or 40b over the IP network 30. In one embodiment, the incoming call may be a session initiation protocol (SIP) invite. The incoming call includes a source telephone number and a destination telephone number. The source telephone number of the incoming call is the remote public telephone number of the remote telephone 40a or 40b, and the destination telephone number of the incoming call is the local public telephone number of the switch 20.

The searching module 24 is operable to search the call record table 21a to find a mapping outgoing call with a destination telephone number the same as the source telephone number of the incoming call, and obtain a communication line number of the mapping outgoing call in the call record table 21a. In one embodiment, assuming the incoming call is from the remote telephone 40b, the searching module 24 finds the mapping outgoing call from the local telephone 10b. Accordingly, the searching module 24 obtains the communication line number of the mapping outgoing call in the call record table 21a, namely the communication line number of the communication line 50b. Then, the communication module 23 sends a ringing signal to the local telephone 10b corresponding to the obtained communication line number of the mapping outgoing call.

In another embodiment, assuming the incoming call is from the remote telephone 40a, the searching module 24 does not find the mapping outgoing call. As such, the communication module 23 sends the ringing signal to all the local telephones 10a-10d.

In one embodiment, the communication module 23 receives the at least one outgoing call from the at least one local telephone 10a-10d, obtains the at least one private telephone number of the at least one local telephone 10a-10d, translate the at least one private telephone number to the local public telephone number of the switch 20, and send at least one SIP invite with the local public telephone number to the at least one remote telephone 40a-40b. For example, assuming that the private telephone number of the local telephone 10b is 6212, and the local public telephone number of the switch 20 is 5432022824, the communication module 23 receives the outgoing call from the local telephone 10b, translates 6212 to 5432022824, and sends an SIP invite with the 5432022824 to the remote telephone 40b.

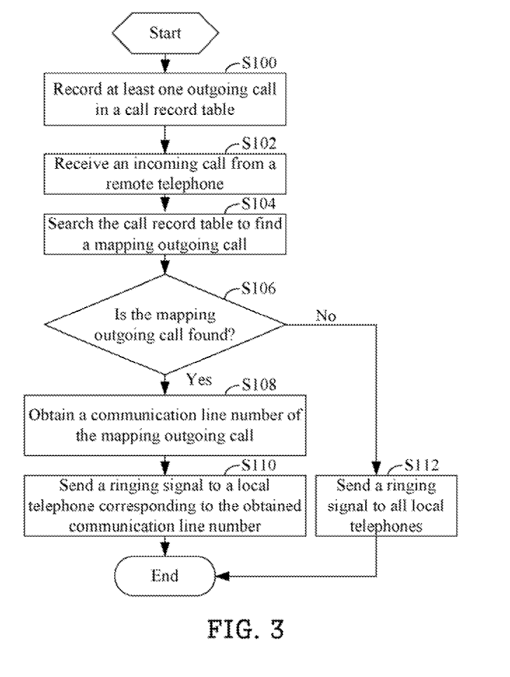

FIG. 3 is a flowchart of one embodiment of a telephone searching method in accordance with the present disclosure. The method may be embodied in the switch 20, and is executed by the functional modules such as those of FIG. 2. Depending on the embodiment, additional blocks may be added, others deleted, and the ordering of the blocks may be changed while remaining well within the scope of the disclosure.

In block S100, the storage system 21 records at least one outgoing call from at least one local telephone 10a-10d to at least one remote telephone 40a-40b in the call record table 21a. In one embodiment, the at least one outgoing call includes at least one communication line number corresponding to the at least one local telephone 10a-10d, at least one destination telephone number, and at least one private telephone number of the at least one local telephone 10a-10d. The at least one destination telephone number of the at least one outgoing call is at least one remote public telephone number of the at least one remote telephone 40a-40b. For example, if one outgoing call is from the local telephone 10b to the remote telephone 40b, the call record table 21a records the communication line number 2 of the communication line 50b, the private telephone number 6212 of the local telephone 10b, and the remote public telephone number 9561033715 of the remote telephone 40b.

In block S102, the communication module 23 receives an incoming call from the remote telephone 40a or 40b over the IP network 30 when the remote telephone 40a or 40b dials the local public telephone number of the switch 20. In one embodiment, the incoming call may be an SIP invite. The incoming call includes a source telephone number and a destination telephone number. The source telephone number of the incoming call is the remote public telephone number of the remote telephone 40a or 40b, and the destination telephone number of the incoming call is the local public telephone number of the switch 20.

In block S104, the searching module 24 searches the call record table 21a to find a mapping outgoing call with a destination telephone number the same as the source telephone number of the incoming call.

In block S106, the searching module 24 determines whether the mapping outgoing call is found.

In one embodiment, assuming the incoming call is from the remote telephone 40b, the searching module 24 finds the mapping outgoing call from the local telephone 10b in the call record table 21a. As such, in block S108, the searching module 24 obtains the communication line number of the mapping outgoing call in the call record table 21a, namely the communication line number of the communication line 50b.

In block S110, the communication module 23 sends a ringing signal to the local telephone 10b corresponding to the obtained communication line number of the mapping outgoing call.

In another embodiment, assuming the incoming call is from the remote telephone 40a, the searching module 24 does not find the mapping outgoing call in the call record table 21a. As such, the communication module 23 sends the ringing signal to all the local telephones 10a-10d, as shown in block S112.

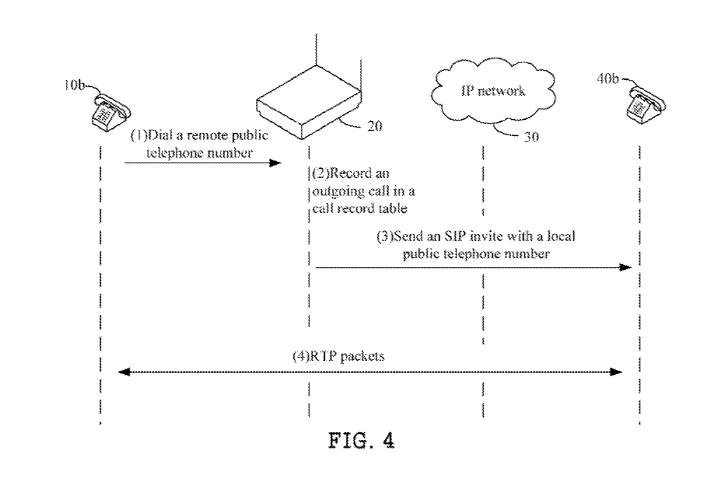

FIG. 4 is a transport diagram showing the switch 20 of FIG. 2 processing an outgoing call in accordance with the present disclosure. In one embodiment, it is assumed that the communication line number of the communication line 50b is 2, the private telephone number of the telephone 10b is 6212, the local public telephone number of the switch 20 is 5432022824, and the remote public telephone number of the remote telephone 40b is 9561033715.

Initially, the local telephone 10b dials a remote public telephone number 9561033715 of the remote telephone 40b, and accordingly the switch 20 receives an outgoing call from the local telephone 10b via the communication line 50b.

Then, the switch 20 records the outgoing call from the local telephone 10b in the call record table 21a. In detail, the switch 20 records the communication line number 2 of the communication line 50b, the private telephone number 6212 of the local telephone 10b, and the remote public telephone number 9561033715 of the remote telephone 40b in the call record table 21a. It should be noted that the remote public telephone number 9561033715 of the remote telephone 40b is the destination telephone number of the outgoing call from the local telephone 10b to the remote telephone 40b.

Afterwards, the switch 20 translates the private telephone number 6212 of the local telephone 10b to the local public telephone number 5432022824 of the switch 20, and sends an SIP invite with the local public telephone number 5432022824 to the remote telephone 40b over the IP network 30.

Finally, the local telephone 10b transmits real-time transport protocol (RTP) packets to and receives RTP packets from the remote telephone 40b after the remote telephone 40b accepts the SIP invite. In other words, the local telephone 10b engages in voice communications with the remote telephone 40b.

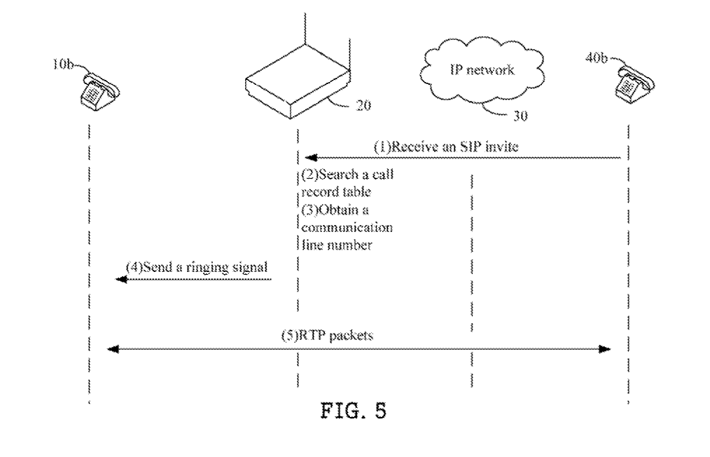

FIG. 5 is a transport diagram showing the switch 20 of FIG. 2 processing an incoming call in accordance with the present disclosure. The incoming call of this embodiment corresponds to the outgoing call of FIG. 4.

Initially, the remote telephone 40b dials the local public telephone number 5432022824 of the switch 20, and accordingly the switch 20 receives an incoming call, namely an SIP invite, from the remote telephone 40b over the IP network 30. In one embodiment, the source telephone number of the incoming call is the remote public telephone number 9561033715 of the remote telephone 40b, and the destination telephone number of the incoming call is the local public telephone number 5432022824 of the switch 20.

Then, the switch 20 searches the call record table 21a to find a mapping outgoing call with a destination telephone number the same as the source telephone number of the incoming call. In one embodiment, the mapping outgoing call is the outgoing call from the local telephone 10b to the remote telephone 40b.

When the switch 20 finds the mapping outgoing call from the local telephone 10b in the call record table 21a, the switch 20 obtains the communication line number of the mapping outgoing call in the call record table 21a, namely the communication line number 2 of the communication line 50b.

Then, the switch 20 sends a ringing signal to the local telephone 10b corresponding to the communication line number 2 of communication line 50b.

Finally, the local telephone 10b transmits RTP packets to and receives RTP packets from the remote telephone 40b after the local telephone 10b accepts the incoming call. That is, the local telephone 10b engages in voice communications with the remote telephone 40b.

Thus, the switch 20 records at least one outgoing call in the call record table 21a, and then searches the call record table 21a to find one outgoing call mapping with the incoming call. As such, the switch 20 can quickly find a telephone mapping with the incoming call.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A switch communicating with a plurality of local telephones via a plurality of communication lines, and communicating with a plurality of remote telephones over an Internet protocol (IP) network, each of the plurality of communication lines corresponding to one of the plurality of local telephones and being assigned a communication line number, the switch comprising:
at least one processor;
a storage system operable to store a call record table for recording at least one outgoing call from at least one local telephone to at least one remote telephone, wherein the at least one outgoing call includes at least one communication line number corresponding to the at least one local telephone and at least one destination telephone number;
one or more programs that are stored in the storage system and are executed by the at least one processor, the one or more programs comprising:
a communication module operable to receive an incoming call with a source telephone number from one of the remote telephones over the IP network;
a searching module operable to search the call record table to find a mapping outgoing call with a destination telephone number the same as the source telephone number of the incoming call, and obtain a communication line number of the mapping outgoing call in the call record table;
wherein the communication module is further operable to send a ringing signal to the local telephone corresponding to the obtained communication line number.

2. The switch of claim 1, wherein the incoming call is a session initiation protocol (SIP) invite from the one of the remote telephones.

3. The switch of claim 1, wherein the communication module is further operable to send the ringing signal to all the local telephones when the searching module does not find the mapping outgoing call.

4. The switch of claim 1, wherein the switch has a local public telephone number, and each of the local telephones has a private telephone number.

5. The switch of claim 4, wherein the communication module is further operable to receive the at least one outgoing call from the at least one local telephone, obtain at least one private telephone number of the at least one local telephone, translate the at least one private telephone number to the local public telephone number, and send at least one SIP invite with the local public telephone number to the at least one remote telephone over the IP network.

6. The switch of claim 4, wherein the at least one destination telephone number of the at least one outgoing call is at least one remote public telephone number of the at least one remote telephone.

7. The switch of claim 6, wherein the source telephone number of the incoming call is a remote public telephone number of the one of the remote telephones, and a destination telephone number of the incoming call is the local public telephone number of the switch.

8. A telephone searching method of a switch, the switch communicating with a plurality of local telephones via a plurality of communication lines, and communicating with a plurality of remote telephones over an Internet protocol (IP) network, each of the plurality of communication lines corresponding to one of the plurality of local telephones and being assigned a communication line number, the telephone searching method comprising:
recording at least one outgoing call from at least one local telephone to at least one remote telephone in a call record table, wherein the at least one outgoing call includes at least one communication line number corresponding to the at least one local telephone and at least one destination telephone number;
receiving an incoming call with a source telephone number from one of the remote telephones over the IP network;
searching the call record table to find a mapping outgoing call with a destination telephone number the same as the source telephone number of the incoming call;
obtaining a communication line number of the mapping outgoing call in the call record table; and
sending a ringing signal to the local telephone corresponding to the obtained communication line number.

9. The telephone searching method of claim 8, wherein the incoming call is a session initiation protocol (SIP) invite from the one of the remote telephones.

10. The telephone searching method of claim 8, further comprising: sending the ringing signal to all the local telephones if the mapping outgoing call is not found in the call record table.

11. The telephone searching method of claim 8, wherein the switch has a local public telephone number, and each of the local telephones has a private telephone number.

12. The telephone searching method of claim 11, further comprising:
receiving the at least one outgoing call from the at least one local telephone;
obtaining at least one private telephone number of the at least one local telephone;
translating the at least one private telephone number to the local public telephone number; and
sending at least one SIP invite with the local public telephone number to the at least one remote telephone.

13. The telephone searching method of claim 11, wherein the at least one destination telephone number of the at least one outgoing call is at least one remote public telephone number of the at least one remote telephone.

14. The telephone searching method of claim 13, wherein the source telephone number of the incoming call is a remote public telephone number of the one of the remote telephones, and a destination telephone number of the incoming call is the local public telephone number of the switch.
